(19) United States
(12) Patent Application Publication
(10) Pub. No.: US 2006/0091671 A1
(43) Pub. Date: May 4, 2006

(54) System and method for applying documents to substrates

(76) Inventor: Bruce Raming, Northbrook, IL (US)

Correspondence Address: Hovey Williams LLP, Suite 400, 2405 Grand Blvd, Kansas City, MO, 64108, US

(21) Appl. No.: 11/182,968

(22) Filed: Jul. 15, 2005

Related U.S. Application Data
(60) Provisional application No. 60/624,384, filed on Nov. 2, 2004.

(51) Int. Cl. B42D 15/00

(52) U.S. Cl. 283/105

(57) ABSTRACT

A system for applying documents to containers is provided which economizes the use of paper and equipment in the sequential placement of labels and other documents. The system includes document supply source providing two or more different documents, for example a packing list and a shipping label, may be alternatively and sequentially delivered to placement apparatus. The placement apparatus is operatively connected to a computer for receiving information corresponding to the container and information to be imprinted on the document. The system is configured to maintain the placement apparatus and the container in a stationary relationship relative to one another during application of the two or more different documents.

This application claims the benefit of U.S. Provisional Application No. 60/60/624,384, Filed: Nov. 2, 2004.

### BACKGROUND OF THE INVENTION

1. Field of the Invention

This invention concerns a system for applying documents to a substrate such as a container whereby two or more different documents are supplied to a placement apparatus and alternately affixed to a substrate. The invention includes a corresponding method of alternately applying two or more different documents by a placement apparatus, preferably a printing and applicating machine, with the documents in registry and with the substrate remaining substantially stationary during placement on the receiving substrate.

2. Description of the Prior Art

The opportunities presented by online and catalog shopping, the automated handling of containers and the emergence of economical express shipping has placed increasing challenges on packaging and labeling systems. With the increase in the number of packages being shipped, there have arisen corresponding concerns about the security for such containers, and the desire to minimize the ability of thieves to readily discover the container contents.

As a result, I initially developed a package labeling system which is particularly useful with two-sided (duplex) printers, as shown, for example, in my U.S. Pat. No. 6,213,518. This labeling system presented substantial advantages over prior labeling systems, but to take full advantage of the system, a duplex printer is required. An alternative system which most advantageously utilizes two print and apply machines positioned adjacent to a conveyor is shown in my U.S. Pat. No. 6,616,189. This invention provides for the sequential application of documents such as labels on containers so that a large number of containers can be quickly and automatically processed.

While both of the aforementioned systems represent substantial improvements over the prior art, there is a need for a labeling system which provides increased automated capacity relative to those currently available for duplex printers, yet requiring a smaller initial investment in equipment and a reduced interrelationship of scanners, computers and applying equipment than that as shown in my U.S. Pat. No. 6,616,189. That is to say, an opportunity exists for an improved document application system which retains the benefits of automated label application while enjoying a simplicity of design to minimize cost.

### SUMMARY OF THE INVENTION

This object is largely achieved by the system and method of the present invention. In accordance with the present invention, two or more different documents, such as labels, may be alternately and automatically affixed to a substrate such as a container by a single applicator, or by two different applicators, while the substrate remains stationary. While the invention is illustrated with respect to specific types of documents, for example packing lists and shipping labels, it is to be understood that the invention can be used to print a variety of different documents such as customer replies, return postcards, receipts, and return labels, to name only a few examples.

One principal difficulty with the prior art is the use of a conveyor for transporting the container during the document application process. Because the conveyor moved the box relative to the document applicator, the applicator necessarily had to read the information on the document and then hit a moving target. When two or more document applicators were used, the problem is compounded. If the speed of the conveyor fluctuates, or the two document applicators are not in precise relationship to one another, or the scanning indicators are misaligned relative to their recorded position relative to the applicators, then the labels may possibly be misapplied. While application of two or more documents in perfect registry is a desired goal is difficult to achieve, the fact that the second document must be placed in registry atop the first document already on a container which is moving vastly complicates the task.

The present invention overcomes this problem and achieves substantially greater accuracy while reducing complexity and cost. First, in the most preferred embodiments, the system of the present invention employs a single print and apply machine to both print and apply two different documents at the same location. By alternating and sequentially printing and applying first one document, then a second different document, the problems of misalignment between two different print and apply stations are vastly reduced. The two different documents may be supplied to the same machine in alternating sequence in a variety of ways. For example, the documents may be provided separately and supplied by magazines to a print and apply station which alternates between the different supply sources to apply first one, then the other document. More preferably, and simply, a single supply source is provided with a continuous carrier sheet on which different documents are adhesively carried. The single supply source can be initially provided as a roll, and unwound as the documents are sequentially applied. The common carrier further helps to align the documents as they are fed to the applicator. Thus, two different documents are applied one after the other to a container, the documents most preferably being affixed in superposed, aligned relationship. Because the documents are most preferably printed and applied such that a second immediately succeeds the first, the likelihood of mis-sequencing two different applicators or loss of registration over time is drastically reduced.

Second, the present invention reduces the problems associated with costs associated with establishing and maintaining timing between two stations and a moving target by keeping the applicator stationery relative to the target. When two applicators are employed, the container is conveyed by a conveyor to a stationary first applicator and maintained stationary while the first document is applied, then advanced to a stationary second applicator and again maintained stationary while the second document is applied, most preferably in registry over the first document. Alternatively, the container is positioned and maintained stationary during the printing and application of a first document and then maintained stationary during printing and application of a second different document sequentially printed and applied by a single stationary applicator, then moved to permit a second container to occupy the application station. In this system, a plurality of different processing stations may be employed along a single conveyor each for processing containers thereon and to increase total throughput. In a third alternative, two applicators are used adjacent respective, separately actuated conveyors. In the third alternative, an optional supply conveyor may deliver the containers to a first conveyor having a first applicating apparatus positioned adjacent thereto. The container is advanced to a desired application location, whereupon a first document is applied while the first conveyor maintains the container stationary. Then, the first conveyor advances the container to a second conveyor which, when access to a second application apparatus is available, advances the container downstream to a second application apparatus. When the container is in the desired position relative to the second application apparatus, a second document is applied in superposed, substantially covering relationship over the first document while the second conveyor maintains the container substantially stationary. Thus, each of the first conveyor and second conveyor is provided with a motor drive unit capable of indexing the containers into position and coupled to a control unit such as a computer for controlling the conveyors and application apparatuses.

The present invention permits the use of documents on a carrier sheet which are initially produced in sequential, longitudinal alignment on the carrier sheet. This permits the use of alternating documents of different sizes to conserve materials, while allowing the placement of a first one documents and a second document in registry thereon. This is particularly advantageous to permit the second document to mask the indicia on the first document, while preserving the objects of permitting removal of a portion of one document along lines of weakness to gain access to a second one of the documents. The placement of the documents in registry with the second document superposed above the first document allows both the first and second documents to have respective lines of weakness in proper positioning. Further, each of the documents are preferably provided with adhesive on one side thereof on only a portion of the document, so that there is an adhesive free zone on each of the documents placed in registry. Thus, the second document can be applied to adhere to both the substrate, such as a container, and the first document if desired. The use of a first document of a relatively smaller size than a second document on the carrier sheet not only conserves material but facilitates adhesion of the documents to the carrier. For example, if the first document failed to achieve full adhesion, the placement of the second document would serve to further adhere the first document to the substrate. The present invention may thus continue to provide many of the advantages and achieve the purposes as set forth in my U.S. Pat. Nos. 6,186,554, 6,213,518, incorporated herein by reference, as well as that of my U.S. Pat. No. 6,616,189, incorporated herein by reference.

Most preferably, the first and second documents, as well as the container, are provided with information, including scannable information. The scannable information may be provided by directly printing indicia on the container and documents, or by labels, tapes, tags or other attachments. By way of example, the scannable information may be provided by scannable indicia such as bar codes or optical character recognition characters which may be electronically read, or by radio frequency identification (RFID) tags, labels, tapes, or the like which may emit a signal either independently or when subjected to interrogation, as in a transponder. As used in this application, “RFID labels” are intended to mean tags, labels, tapes or other physical carriers which include an RFID component. By this way, the scannable information may be coded into the scannable indicia or RFID component whereby the documents and container may be electronically identified, their processing recorded, and the information communicated to a computer for the storage of information in a database or an information storage and retrieval device.

Other and further benefits of this invention will be readily apparent to those skilled in the art with reference to the description and drawings referenced below.

### BRIEF DESCRIPTION OF THE DRAWINGS

FIG. 1 is a plan view of the face side of a document used as a shipping label for use as a part of a sequentially placed shipping and packing label in accordance with the present invention, showing the indicia printed thereon and the lines of weakness to permit removal of the center section for inspection of the packing list positioned therebeneath;

FIG. 2 is a plan view of the reverse side of the document of FIG. 1, showing the positioning of adhesive applied to a surrounding border portion and the printing of optional masking indicia to prevent premature viewing of another document used as a packing list;

FIG. 3 is a plan view of the front side of another document useful as a packing list and typically applied as a first document in conjunction with the document of FIG. 1, the latter applied over the first document as a second document, the first document showing the indicia printed thereon and the lines of weakness for permitting removal of a center portion from two adjacent retaining strips;

FIG. 4 is a plan view of the back side of the first document of FIG. 3, showing the lines of weakness and the application of adhesive to the retaining strips;

FIG. 5 is a perspective view of a container with the sequentially placed first and second documents of the present invention showing the center section of the second document used as a shipping label partially removed to permit viewing and removal of a center portion of the first document used as a packing list;

FIG. 6A is a fragmentary view of a continuous document supply strip showing the back side thereof, and showing first documents and second documents in dashed lines to indicate their position on the front side of the of the document supply strip, and showing the use of sequence markings on the back side of the carrier sheet positioned longitudinally on the document supply strip before the first document and between the first document and the second document;

FIG. 6B is a fragmentary view of the front side of the continuous document supply strip wherein first documents and second documents are alternately positioned in alignment on a carrier web for continuously and alternately feeding the first and second documents to a document applicator;

FIG. 7 is a plan view of a return label showing the back side thereof which may be provided as a part of the first or second documents hereof;

FIG. 8 is a diagrammatic view of an apparatus in accordance with the invention hereof, wherein the continuous document supply strip is fed to a print and apply machine positioned adjacent a platform and showing the placement of a first document on a container;

FIG. 9 is a diagrammatic view similar to FIG. 8, showing the container positioned on a platform and the attachment of the second document to the container in registry over the first document;

FIG. 10 is a diagrammatic view of an apparatus similar to FIGS. 8 and 9, wherein the containers are delivered to a print and apply machine by a conveyor and stopped for application of a first document;

FIG. 11 is a diagrammatic view of the apparatus of FIG. 10, showing the application of a second document in registry over the first document while the container is stationary;

FIG. 12 is a diagrammatic view of an alternate apparatus similar to that of FIGS. 8-11, but wherein containers are supplied to two successive print and apply apparatuses by respective conveyors which index the containers to respective application locations where the first document is initially applied to a container which is stopped, and then the container is advanced to the second apparatus where the second document is applied to the container which is stopped;

FIG. 13 is a plan view of the second document applied over the first document on a container, showing the inclusion of an additional transverse line of weakness in the center section of the second document to provide a detachable return label as shown in FIG. 7; and

FIG. 14 is a plan view of the first document as in FIG. 13 and showing the center section of the second document removed to expose the center portion of the first document which is centered and aligned with respect to the second document and the side margins of the first document being shown in phantom lines illustrating the attachment of the U-shaped border portion of the second document adhering to both the container and the side retaining strips of the first document.

### DESCRIPTION OF THE PREFERRED EMBODIMENT

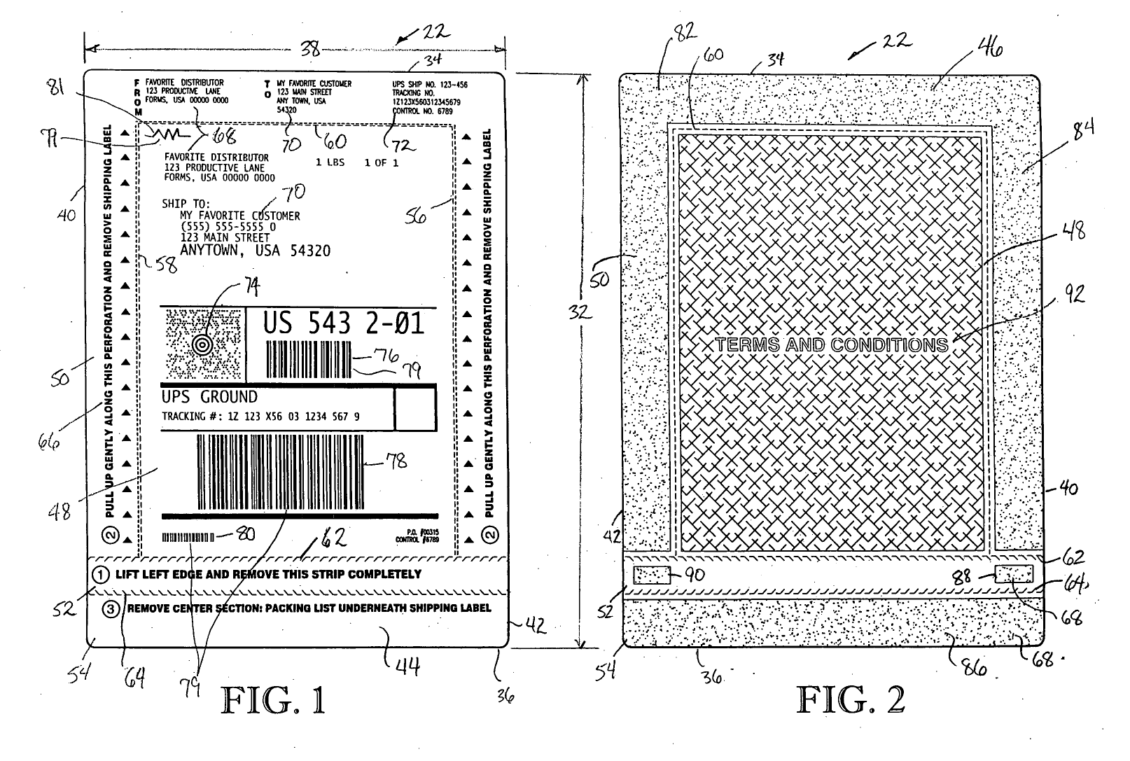

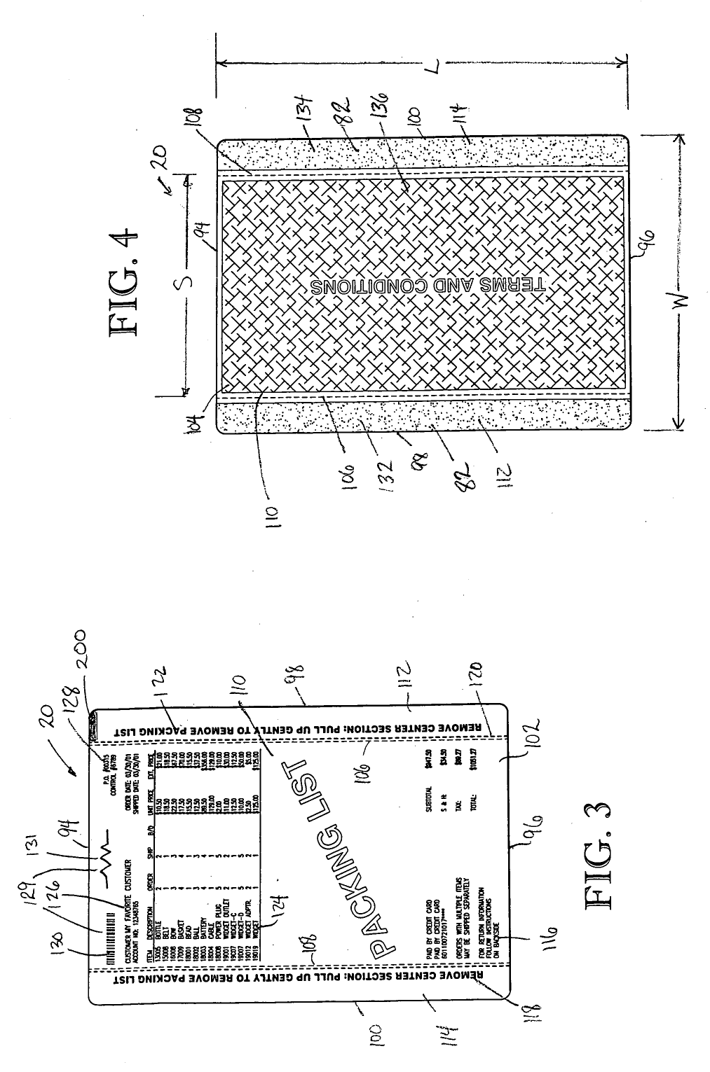

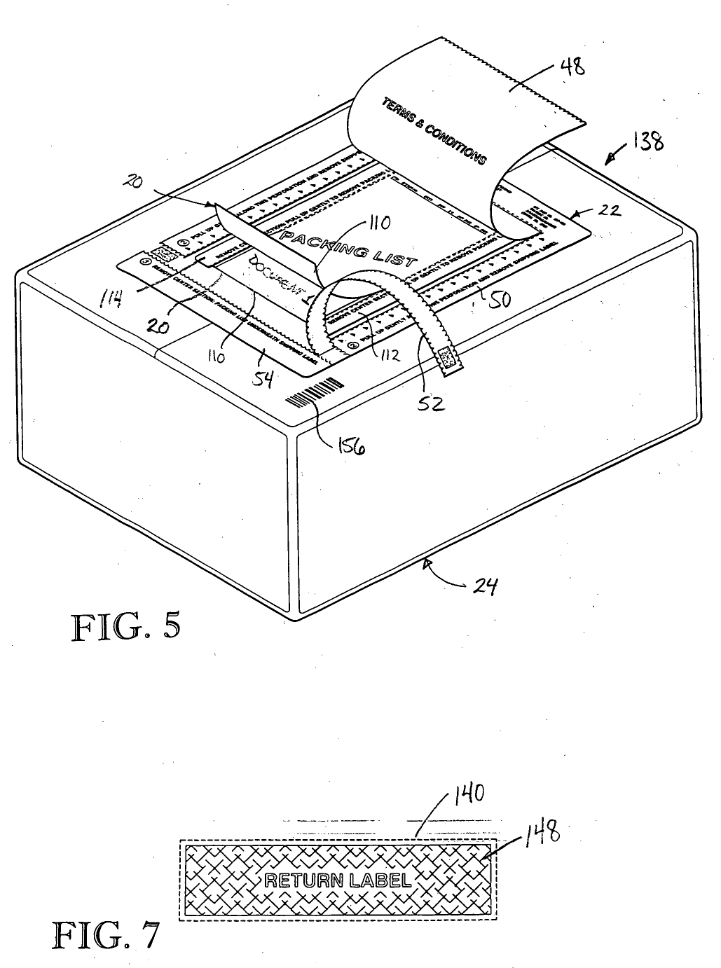

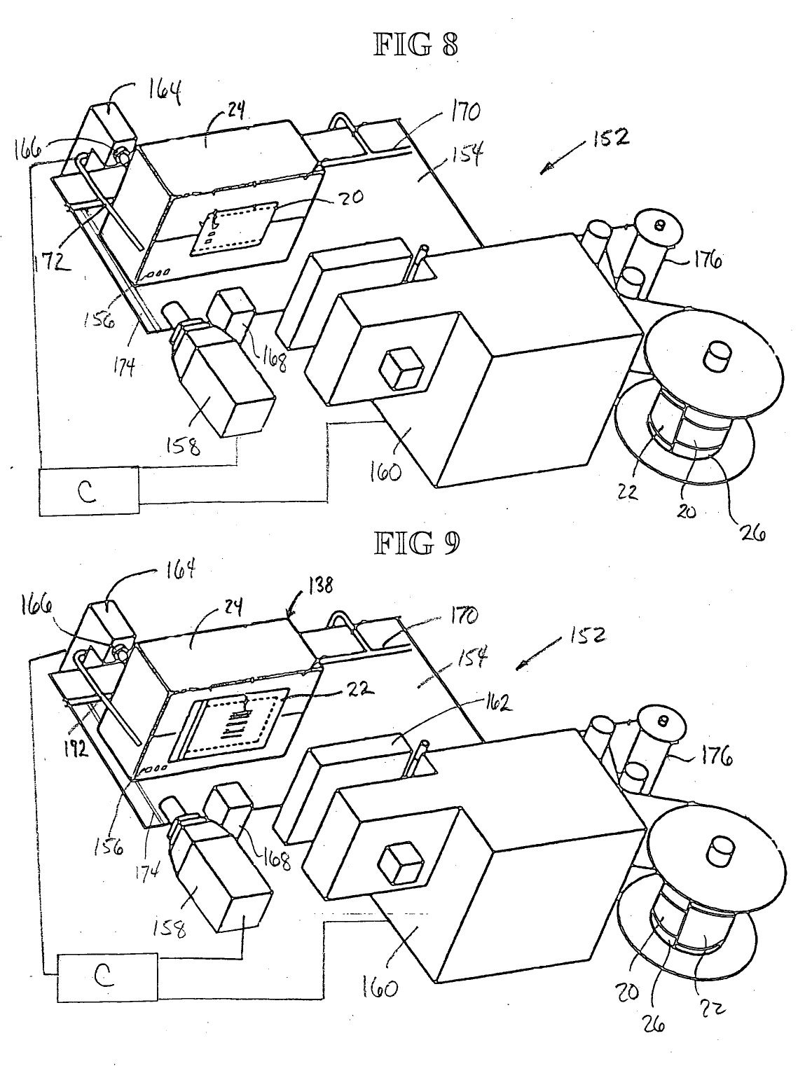

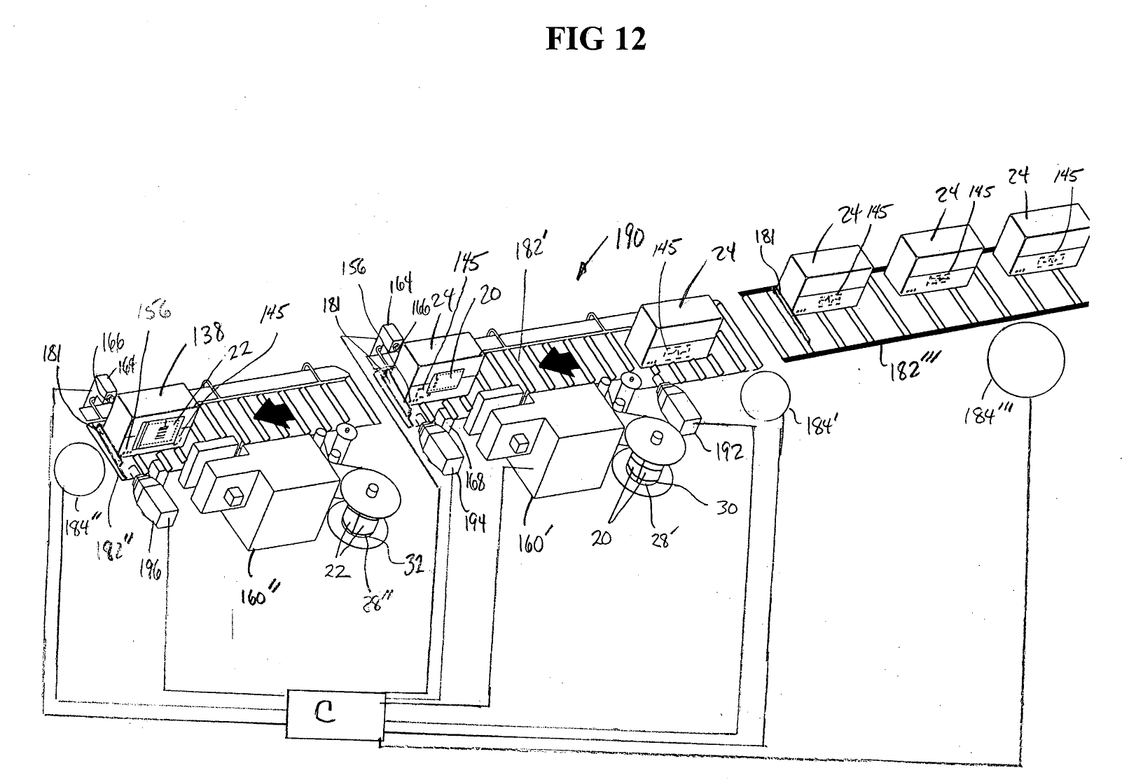

Referring now to the drawings, a first document 20 is shown generally in FIGS. 3 and 4 and a second document 22 is shown generally in FIGS. 1 and 2. The terms “first” and “second” as used herein are provided for convenience to refer to the order of placement of the documents 20 and 22 on a container 24 in accordance with the present invention as shown in FIG. 5. In this regard, the end result of the present invention is intended to be the same as that shown in my U.S. Pat. No. 6,616,189. However, as illustrated in FIG. 6, the first document 20 and second document 22 are most preferably incorporated in a continuous document supply strip 26 which further includes a carrier sheet 28 provided with a release coating on at least one side, whereby the documents 20 and 22 may be alternately placed for attachment to the container 24 in superposed relationship in accordance with the systems shown in FIGS. 8 and 9 or FIGS. 10 and 11. Alternatively, respective continuous document supply strips 30 and 31 each having only first documents 20 and second documents 22 thereon for use in a system as illustrated in FIG. 12. The continuous document supply strips 26, 30 and 31 are most preferably configured to be provided as rolls mountable on printing and applicating machinery as described further herein, and thus the term “continuous” should be given its ordinary meaning in the printing industry, rather than being considered as a strip of infinite length. Further, while illustrated in the context of a container 24 being the same size, for example as shown in FIGS. 8, 9, 10, 11 and 12, it should be understood that the documents may be applied to other substrates and that the containers 24 may substantially vary in size, weight and configuration all within the context of the invention described herein.

In greater detail, the second document 22 may be used as a shipping label and preferably includes a longitudinal dimension 32 extending between a leading edge 34 and a trailing edge 36, and a transverse dimension 38 extending between a first side edge 40 and a second side edge 42. The second document 22 has a face side 44 as shown in FIG. 1 and a reverse side 46 as shown in FIG. 2. The second document 22 includes a center section 48, a U-shaped border portion 50, a tear strip 52 and a base strip 54. Lines of weakness provided by scoring or more preferably by perforation aid in permitting removal of the center section 48 and include first line of weakness 56 and second line of weakness 58, both extending longitudinally and preferably parallel respectively proximate the first side edge 40 and the second side edge 42. A cross line of weakness 60 extends across the second document 22 proximate to and spaced from the leading edge 34 between the first line of weakness 56 and the second line of weakness 58, but preferably does not extend outboard of either first line of weakness 56 or second line of weakness 58. As used herein, “outboard” refers directionally toward the areas more proximate the edges 34, 36, 38 and 40, and “inboard” relates directionally to the inner or center part of the second document 22. The tear strip 52 is preferably defined by inboard transversely-extending lines of weakness 62 and outboard transversely extending line of weakness 64, both of which are parallel to the cross line of weakness 60.

The second document 22 is provided with printed indicia including instructions 66, shipper identification 68, recipient identification 70, tracking and billing information 72, target indicia 74, and scannable information 79 provided in a manner such as scannable indicia 76, 78 and 80 of the type well known, such as UPC bar coding. Alternatively, the scannable information 79 may be provided in an alternative form, such as an RFID label 81 coupled to or inserted into the container and/or the first and/or second documents so as to provide a radio or other frequency signal either under its own power or provided as a transponder so that the signal is generated upon interrogation. Such RFID tags, tapes and labels are well known to those skilled in the art and are shown and described in, for example, U.S. Pat. Nos. 6,281,795, 6,478,229, 6,523,752, 6,557,758, 6,624,362, 6,851,617, and 6,869,021, the disclosures of which are incorporated herein by reference. The instructions 66 may include directions for use and line indicators which assist the recipient in identifying the lines of weakness 56, 58, 60, 62, and 64. The shipper identification 68, recipient information 70 and tracking and billing information 72 may be provided in optical character recognition type font if it is desirable that this information be electronically read and stored, or other type font as desired, and may be reprinted in multiple different locations as desired by the sender. The target indicia 74 may be utilized by the printing and applicating machines 160 for printing and applying the second document to aid in locating the printing, or by the shipping carrier for identifying the documents such as labels on the container for locating and then scanning the information carried thereon. The scannable information 79, which can be provided as an RFID label 81, or alternatively, as shown, as scannable indicia 76, 78, and 80 may be utilized during application of the labels for determining and verifying correct order and billing information and assisting in the routing of the container 24 both initially to the correct carrier and during shipping by the shipping carrier until delivery. Some of the indicia may be preprinted, such as the instructions 66, the shipper identification 68 and the target indicia 74, or this indicia as well as the remaining indicia may be variable printed for different second documents 22 such as those used as shipping labels, to correspond to a particular container 24. This variable printing may be performed by printing and applicating machines 160 as described herein.

Adhesive 82, such as pressure-sensitive adhesive is applied to the reverse side 46 of the second document 22 to aid in adhering the second document 22 to the container 24. Adhesive 82 may be applied in a variety of different ways, such as by a spray head or the like to predetermined locations on the reverse side 46, spaced or recessed about 1 mm from both the edges and the lines of weakness to avoid bleeding of the adhesive beyond the edges and into the lines of weakness. One such predetermined location is a U-shaped adhesive pattern 84 applied outboard the lines of weakness 56, 58, and 60 onto the reverse side 46 of the border portion 48 as shown in FIG. 2. A second location 86 of adhesive 82 is applied along the base strip 54. Adhesive 82 may also be applied on the reverse side 56 of the tear strip 52 in third location 88 proximate the first side edge 38 and at a fourth location 90 proximate the second side edge 42 as shown in FIG. 2. Masking indicia 92 may be preprinted prior to application of the adhesive such as by grey ink or reverse printing on reverse side 46 of the center section 48 to inhibit premature viewing of the first document 20 when the latter is used as a packing list.

The first document 20 is sized and positioned on the container 24 complemental to the second document 22 and preferably to nest therebeneath when applied to a container or other substrate. The first document 20 has a length L which extends between a leading margin 94 and a trailing margin 96, and a width W which extends between a first side margin 98 and a second side margin 100. The length of the first document 20 is preferably less than the longitudinal dimension 32 of the second document 22 and also less than the longitudinal distance D between the cross line of weakness 50 and the inboard transverse line of weakness 52. The width W of the first document 20 is preferably less than the transverse dimension 38 of the second document 22 and also less than the transverse distance T between the first line of weakness 56 and the second line of weakness 58 of the second document 22. The first document 20 includes a front side 102 shown in FIG. 3, and a back side 104 shown in FIG. 4. Two longitudinally-extending first document lines of weakness 106 and 108 are preferably parallel and formed by scoring or more preferably perforations. The lines of weakness 106 and 108 extend between the leading margin 94 and the trailing margin 96 and divide the first document 20 into a center portion 110 having a transverse width S and two retaining strips 112 and 114. The transverse width S is less than the transverse distance T. The front side 102 may be printed with indicia 116 including instructional indicia 118 such as location lines 120 in substantial registry with lines of weakness 106 and 108, and directions 122, content indicia 124 corresponding to the contents of the container 24 and cost information, identification indicia 126 to identify the customer name and account number, tracking and control indicia 128 setting forth information such as the purchase order, order control number, order and shipping date, and scannable information 129 which may include scannable indicia 130 such as a UPC bar code or an RFID label 131 encoded with information, whereby the scannable information 129 enables correlation between the second document 22 and the first document 20. Preferably, the scannable indicia 130 is the same as or corresponds to scannable indicia 80 of the second document 22.

The back side 104 of the first document 20 includes first and second regions 132, 134 of adhesive 82 such as pressure-sensitive adhesive applied between the side margins 98 and 100 and the lines of weakness 106 and 108 most proximate thereto. The first and second regions of adhesive are preferably recessed about 1 mm from margins 94, 96, 98 and 100 and also from the lines of weakness 106 and 108. This leaves the back side 104 of center portion 110 free of adhesive 82. The center portion 110 may thus be separated form the container 24 while the retaining strips 112 and 114 remain adhered to the container. The back side 104 of the center portion 110 may be preprinted with terms and conditions or other printing 136 prior to application of the adhesive on the retaining strips which further inhibits premature viewing of the first document content indicia 124.

Both the second document 22 and the first document 20 are preferably initially preprinted with instructional indicia, and, as desired, masking indicia. The adhesive 82 is then applied on the rear side and the back side, respectively of the second document 22 and the first document 20, or to a carrier sheet 28 as shown in FIG. 6. As shown in FIGS. 6A and 6B, the first document 20 and the second document 22 are applied to and mated with the carrier sheet 28 in alternating but longitudinally-aligned relationship thereon as a part of continuous document supply strip 26. The carrier sheet 28 thus serves as a liner and as is well-known in the art, provided with release coating of silicone or the like, whereby the adhesive remains with the first document 20 and the second document 22 upon their removal from the carrier sheet 28. The first and second documents can either be applied to the carrier sheet 28 to form the continuous document supply strip 26, or as is conventional may be die-cut form a continuous web with the excess stripped away to leave the first and second documents releasably adhered to the carrier strip. As may be seen in FIG. 6B, the first document leads the second document in positioning on the carrier sheet 28, and the first and second documents are alternately placed thereon both on the same front side 204 of the carrier sheet, and in certain applications it may be desirable to utilize a sequence mark 200 on either or both of the back side 202 of the carrier sheet 28, and the front side of the first document 20. Thus, when the continuous document supply strip 26 is provided as a roll and unwound, the first and second documents are prepositioned in longitudinal alignment and ready for sequential application to a substrate. As such, the first document 20 and the second document 22, may be provided on rolls for feeding in pre-aligned position to a printing and applicating machine. The first document 20 is applied first to the container 24, and then the second document 22 is applied over the first document 22 and adhered to the container 24 so that the first document 20 is covered by the second document 22 and the retaining strips 112 and 114 may be positioned interiorly of or overlapped by the U-shaped border portion 50, but preferably the center portion 110 is not adhered either to the container 24 or to the second document 22. Once applied, the first document 20, second document 22 and container 24 comprise an applied document system 138.

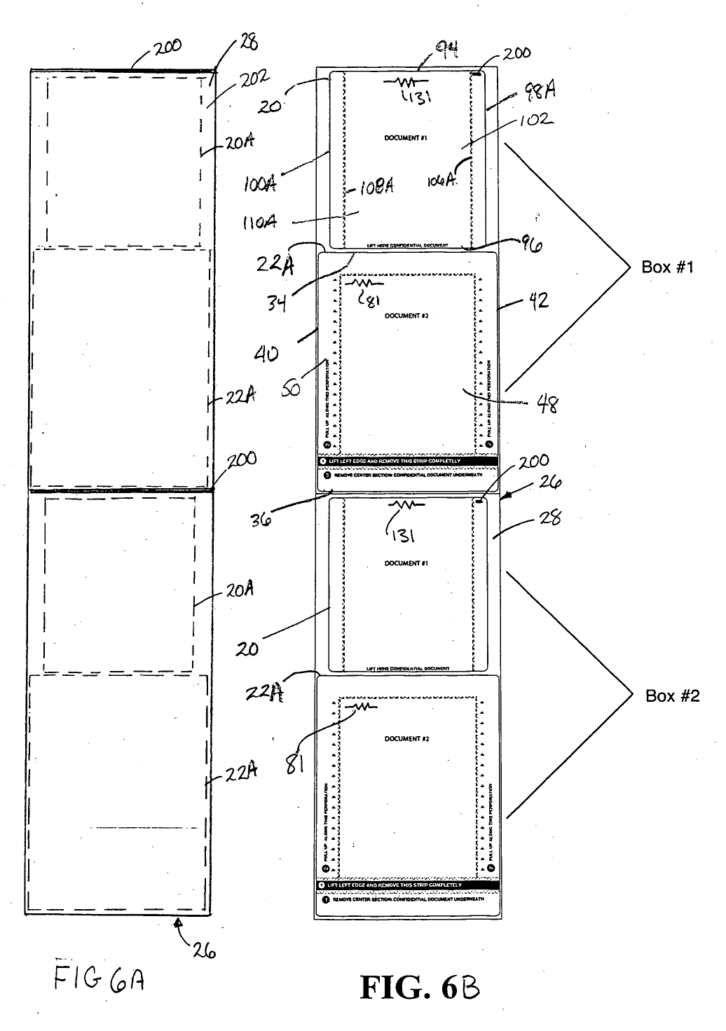

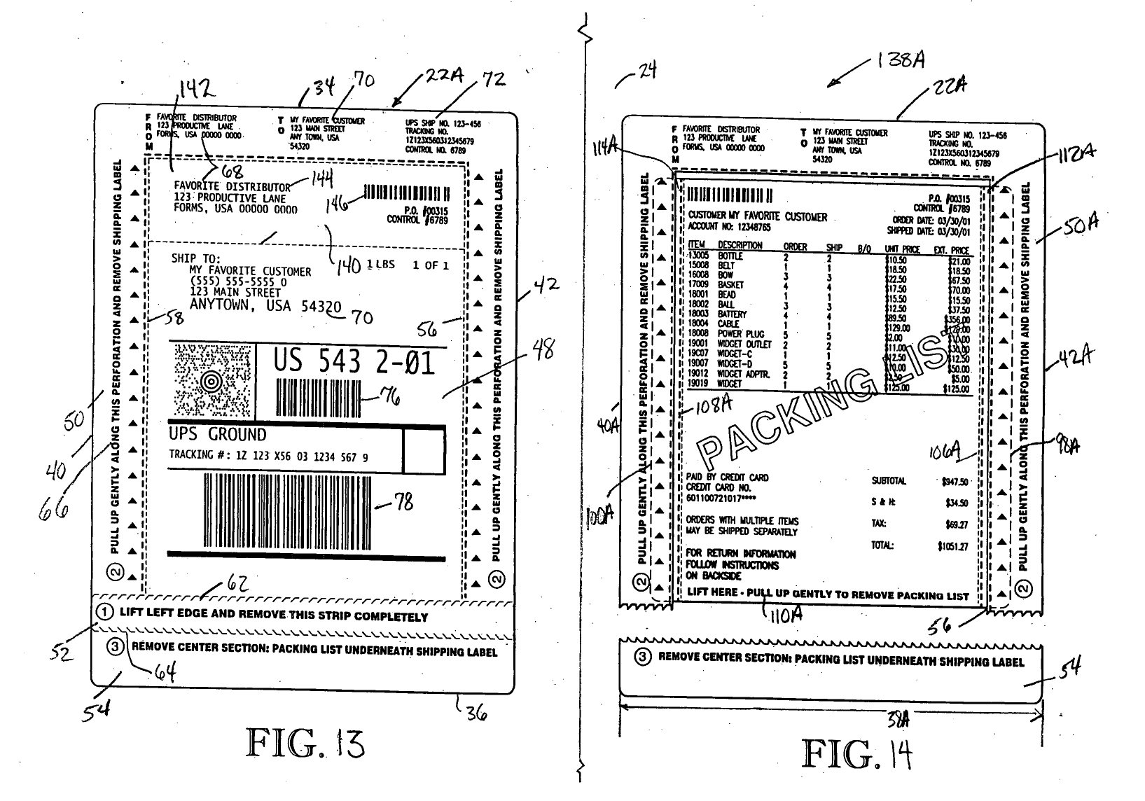

An alternative embodiment of the applied document system 138, including the first document, second document and container as described above, is shown in FIGS. 7, 13 and 14. In this regard, the second document 22A shown in FIGS. 13 and 14 is substantially the same as the second document 22 described above, but includes an integrated return label 140 with a front side 142 including return label information 143 which may be provided to include an RFID label 145 (as used herein, an “RFID label” includes not only labels having an RFID transmitter, but also tags and tapes), and/or printed indicia 144 such as a bar code indicia 146 corresponding to scannable indicia 130, purchase order number, control order number, return address and may also include a returned goods authorization code number. The integrated return label 140 also includes a back side 148 as shown in FIG. 7 when detached from the second document 22A center section, which may be reverse printed with masking indicia or the like and identifies the return label as such. Like the remainder of the center section 48A, shown removed from the second document 22A in FIG. 14, the back side 148 of the return label 140 need not be provided with adhesive, and thus the return label is taped to the container returning the merchandise, if used. Alternatively, the return label 140 could be provided with remoistenable adhesive or a tape with a covering liner so that the return label could be activated for adhering to the container. The return label 140 is defined by an additional transverse line of weakness 150 provided by scoring, or more preferably perforations to permit separation of the return label 140 from the remainder of the center section 48A of the second document 22A. In addition, the first document, 20A of the system 138A shown in FIGS. 7, 13 and 14, is wider between its side edges 98A and 100A, permitting a greater width W and a greater transverse dimension between longitudinally extending lines of weakness 106A and 108A so that center portion 110A is also wider than the center portion 110 of the first document 20. However, the width W is still less than the transverse dimension 38A of the second document 22A, such that at least a part of the adhesively backed U-shaped border portion 50A adheres directly to the underlying container 24 along the side edges 40A and 42A while overlapping and adhering to the retaining strips 112A and 114A of the first document 20A. After application, the first document 20A, the second document 22A, and the container 24 comprise an applied document system 138A. It is to be understood that the second document 22A is substantially the same as the second document 22, simply incorporating an additional return label 140 in the center portion, and thus both of the illustrated second documents 22 and 22A may be used with either of the illustrated first documents 20 and 20A, as shown, for example, in FIG. 6.

The applied document systems 138 and 138A may be effected by the processing assemblies shown in FIGS. 8, 9, 10, 11, and 12. An elegantly simple processing assembly 152 is shown in FIGS. 8 and 9, which includes a platform 154 for receiving the containers 24 thereon. The containers 24 may be provided with unique scannable indicia 156 such as a UPC bar code on a label corresponding to the order, and preferably corresponds to the indicia 80 and 130, so that when scanned, the data of the indicia 80, 130 and 156 is matched and integrated. The processing assembly includes a scanner 158 oriented adjacent the platform 154 for reading the scannable information 143 such as an RFID label 145 placed on or inside the container 24, and/or scannable indicia 156 on the containers 24. While the scanner 158 may be an optical scanner of the type well known for reading bar codes and the like, when RFID labels 145 are used, the scanner 158 may include a transponder interrogator and reader as well known to those skilled in the art. A printing and applicating machine 160 is also positioned adjacent the platform 154 for applying the first and second documents to the container 24. The printing and applicating machines may be, for example, Label-Aire model 3138N print and apply machines from Label-Aire, Inc. of Fullerton, Calif. equipped with a Zebra Pax 170 Print Engine which includes an applicator arm 162 which reciprocates toward and away from the containers positioned on the platform 154. The processing assembly 152 may also include a position indicator 164 such as a touch finger or more preferably an electric eye 166 and an opposite reflector 168 for optically detecting the presence and position of a container on the platform 154 and generating a signal corresponding thereto. Alternately, or in addition to the position indicator 164, the processing assembly 152 may include a back rail 170 and/or a side rail 172 extending transversely therefrom, and a guide line 174 on the platform 154. The guide line 174 and the back rail 170 may be used to position the container for initial application of the first document 20 as shown in FIG. 8. The second document 22, when of greater dimensions than the first document 20, necessitates slight movement of the container 24 in order to center the first document 20 within the second document 22, typically half the difference in width or length. Thus, side rail 172 are designed and positioned relative to the guide line 174 to engage a container 24 when properly positioned on the platform 154 for application of the second document 22. That is to say, a container 24 of any shape, when properly positioned for document application and to maintain that position so that the second document 22 will be applied in registry with the first document 20, will abut both the back rail 170 and the side rail 172. As would be well understood by those skilled in the art, the printing and applicating machine 160, the scanner 158 and the position indicator 164 may be operatively connected to a computer C for processing and transmitting signals therebetween.

The use of the processing assembly 152 is especially easy. The container 24 is positioned on the platform 154 so that the scannable indicia 156 is read by the scanner 158. This transmits a signal to a computer, which in turn sends a signal to the print and apply machine 160 as to the variable indicia to be printed on the first document 20 and the second document 22. When the container 24 is properly positioned against the back rail 170 and on the guide line 174, the print and apply machine may be automatically actuated by the signal sent by the position indicator 164, or by manual actuation by an operator. Upon actuation, the print and apply machine 160 advances the continuous document supply strip 26 to move the first document 20 into position to be printed and then the first document is removed from the carrier sheet 28 and the applicator arm 162 applies the first document to the container as illustrated in FIG. 8. The container 24 is thus preferably maintained in a substantially stationary position during application of the first document 20. Thereafter, operator causes the container 24 to shift slightly along the back rail 170 until it abuts the side rail 172. The side rail 172 is selectively prepositioned relative to the guide line 174 according to the dimensional differences between the first document and second document as illustrated in FIG. 9. The print and apply machine 160 then advances the continuous document supply strip 26 to move the second document 22 for printing of the variable indicia thereon, and then the second document 22 removed from the carrier sheet 28 and is applied in registry with and in superposed relationship over the first document 20 to cover and mask the latter. After the second document 22 is printed and applied to the container 24 as shown in FIG. 9, the completed applied document system 138 (or 138A) is removed from the platform 154 and the process may be repeated for a second container, inasmuch as the first documents and second documents are positioned in alternate, sequential relationship on the continuous document supply strip 26. After the first and second documents are removed from the carrier sheet 28, it is taken up on a reel 176.

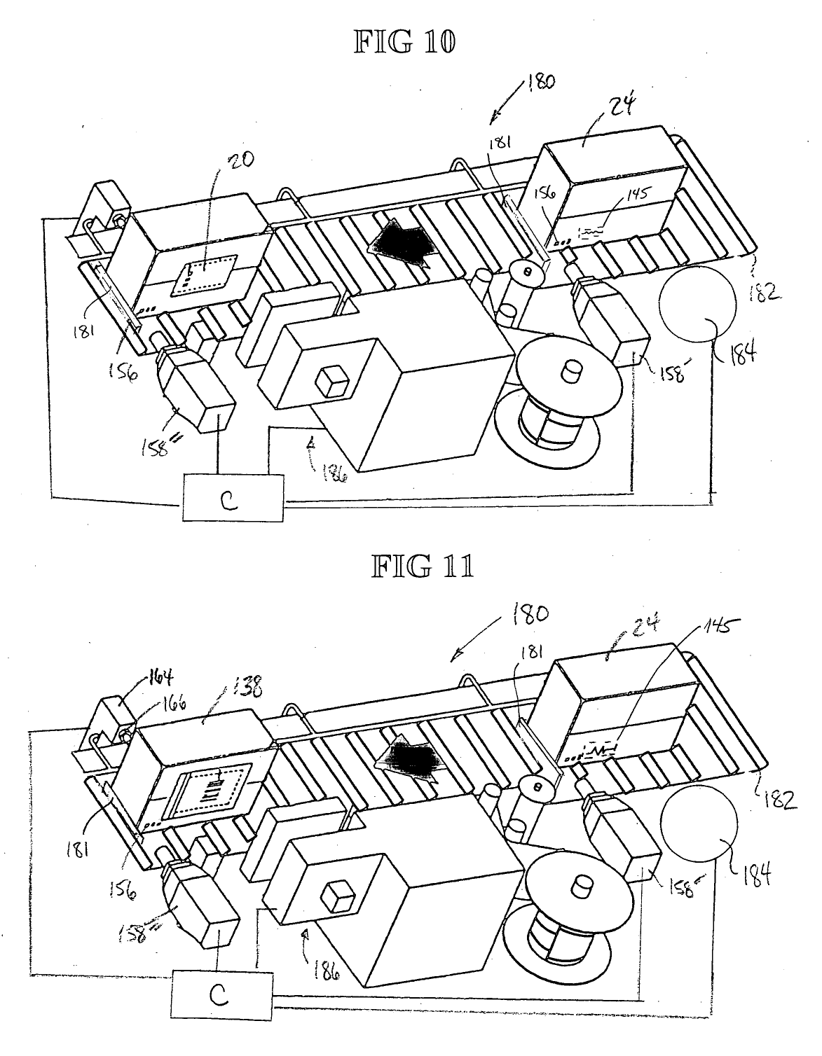

An alternate processing assembly 180 is shown in FIGS. 10 and 11 and includes a conveyor 182 in place of a platform 154, with other components common to both the processing assembly 152 and the processing assembly 180 having the same reference characters. The conveyor 182 may be a roller type conveyor as illustrated in FIGS. 10 and 11, or a belt or other conventional type of conveyor, but as described hereafter, a roller type conveyor presents advantages. The conveyor 182 includes a motor drive 184 with indexing capability operatively coupled to a computer C, such that the driven rollers of the conveyor 182 may be individually driven to selectively advance individual containers 24 at different locations therealong, that is, stopping the conveyor when the container is positioned at a desired location, then reinitiating the motor to drive the conveyor 182 and move the container to the next location. Alternatively, the conveyor rollers may be continuously driven, and the computer C can be coupled to raise a pop-up stop bar 181 between the conveyor rollers to stop the container at the desired location, then lower the stop bar 181 after the printing and applicating machine 160 has printed and applied a document to permit the container to advance along the conveyor. Depending on the size of the rollers of the roller type conveyors and the distance it is desired to move the container so that the documents may be positioned in their respective desired locations, it is possible to remove one or more rollers so that two such stop bars 181 may be moved into adjacent positions in desired spacings (for example, 1 inch to permit centering of the second document over the first document), thereby permitting the container to move into position until stopped by a first such stop bar 181, then move downstream after the first stop bar is lowered and into abutment with the second one of such stop bars 181, such that the second document may be printed and applied over the first document. The computer is also operatively connected to the scanners 158′ and 158″ oriented adjacent the conveyor 182 for reading the scannable indicia 80, 132 and 156 on the containers 24. A printing and applicating machine 160 as described above including the applicator arm 162 is also positioned adjacent the conveyor 182 for applying the first and second documents to the container 24. The processing assembly 180 may also include a position indicator 164 such as a touch finger or more preferably an electric eye 166 and an opposite reflector 168 for optically detecting the presence and position of a container as the conveyor 182 moves the container 24 into position for document application and generating a signal corresponding thereto. The printing and applicating machine with its applicator arm 162, and the position indicator comprise an application station 186.

In use, the conveyor 182 moves each container 24 forward toward the printing and applicating machine 160, and in doing so the upstream scanner 158′ reads the scannable information, such as scannable indicia 156 on the container 24 and communicates that information to the computer, which in turn sends a signal to the printing and applicating machine 160. When the container 24 advances into a position where its leading edge is detected by the position indicator 164, the position indicator sends a signal to the computer C, which in turn signals the motor drive 184 to stop the conveyor 182. Once the container's movement is stopped (either by detecting the absence of movement by the position indicator or by a responsive signal from the motor drive 184 to the computer), the computer signals the printing and applicating machine 160 to begin operation. Upon actuation, the print and apply machine 160 advances the continuous document supply strip 26 to move the first document 20 into position to be printed and then the first document is removed from the carrier sheet 28 and the applicator arm 162 applies the first document to the container as illustrated in FIG. 10. The conveyor 182 remains stopped, and the container 24 is thus preferably maintained in a substantially stationary position during application of the first document 20. Thereafter, the motor drive 184 may selectively drive all or more preferably only one or a few of the rollers of the conveyor to index the container 24 slightly downstream a distance corresponding to half of any preprogrammed difference in the longitudinal dimensions of the first document 20 and second document 22 in order that the second document 22 be properly centered in registry over the first document 21. Alternatively, and perhaps more preferably, pop-up bars 181 may be used when it is desired to avoid the necessity of stopping and staring the motor drive for conveyor 182. Such pop-up bars 181 are driven by motors, hydraulic or pneumatic cylinders or other actuators which are operatively connected to the computer C to rise into the blocking position illustrated in FIGS. 10 and 11 and drop down when in receipt of a signal from the computer C to permit the container 24 to advance on the conveyor. In this circumstance, the motor drive 184 may operate to drive the driven rollers of the conveyor 182 substantially continuously, with the computer C activating the pop-up stop bars 181 to substantially stop the progress of the containers 24 downstream and then drop down to permit a resumption of downstream movement as shown in FIGS. 10 and 11. The pop-up stop bars 181 serve to hold the upstream container in place to avoid interference with the printing and applicating of the documents on the downstream container, and to hold the downstream container in place during printing and application of the first and second documents. Also, the printing and application machine 160 advances the continuous document supply strip 26 to move the second document 22 for printing of the variable indicia thereon, and then the second document 22 removed from the carrier sheet 28 and is applied in registry with and in superposed relationship over the first document 20 to cover and mask the latter. Again, the conveyor 182 preferably remains stopped both during application of the first and the second document, but not necessarily in the time interval between their printing and application. After the second document 22 is printed and applied to the container 24, the completed applied document system 138 (or 138A) is moved down the conveyor 182 past the second, downstream scanner 158″ which detects, reads and confirms the proper application of the second document 22. If an error is detected, a warning signal can be generated to permit the operator to repeat the process. The printing and applicating machine 160, having advanced to place another first document 20 in position for printing and applying to another container, is ready for another container as the conveyor 182 reactuates and moves the next container downstream.

If desired, the processing assembly 180 as shown in FIGS. 10 and 11 can be arranged in tandem or in multiple stations 186 for increased application throughput. For example, as containers 24 move along the conveyor 182 and two stations 186 are provided for processing the containers, a first station 186 would process the first, third, fifth and further odd numbered containers 24, and a second station 186 would process the second, fourth, sixth and further even numbered containers moving along the conveyor 182. For this reason, a roller-type conveyor having a motor drive 184 able to selectively rotate at least some of the individual rollers is particularly desired. By the ability to selectively drive only some of the rollers independent of the other rollers on the conveyor 182, different individual containers 24 may be carried downstream or caused to stop, or to index downstream only a limited amount. Thus, where a plurality of different stations 186 similar to that shown in FIGS. 8 and 9 are provided and operatively coupled to the computer C, the downstream movement of one, some or all of the containers 24 thereon may be selectively controlled. In this way, different containers 24 may be carried to and then stopped for document processing simultaneously at respective stations 186. After document application, the conveyor would again begin moving the containers downstream for further processing or delivery. From the foregoing, it may be understood that three, four, or more such stations 186 could be located on the conveyor 182 to further increase throughput on a single conveyor.

When alternating and sequential first and second (or third or fourth) documents are carried on a continuous document supply strip 26, it may be desirable to preprint a sequence mark 200 on either the front side 102 of the first document 20 or the back side 202 of the carrier sheet 28, or both, which sequence mark 200 is readable by the printing and applying machine 160. The sequence mark 200 may facilitate the operation of some printing and applying machines 160 in advancing the continuous supply strip 26 a sufficient distance to print and feed either a first document or a second document when the first and second documents are of different dimensions.

FIG. 12 illustrates a third alternate processing assembly 190 in accordance with the present invention. In the processing system of FIG. 12, two printing and applying machines 160′ and 160″ are used, as are three different conveyors 182′, 182″, and 182′″. Printing and applying machine 160′ is used to print and apply the first document 20, while printing and applying machine 160″ is used to print and apply the second document 22. Thus, rather than alternating the first document 20 and the second document 22 on a common carrier sheet 28 for application by a single printing and applicating machine 160, the document supply 30 for the printing and applicating machine 160′ has only first documents on a carrier sheet 28′, while the document supply 31 for the printing and applicating machine 160″ has only the second documents 22 on a carrier sheet 28″. The processing system 190 also includes a computer C connected to motor drives 184′, 184″ and 184′″ for the respective conveyors 182′, 182″, and 182′″. Scanners 192 and 194 are positioned adjacent the conveyor 182′ for reading the scannable indicia 156 and 130, respectively, and scanner 196 is positioned further downstream adjacent the conveyor 182″ for reading the scannable indicia 80. Like numbers are otherwise used to indicate common features as described above, for example, the pop-up bars 181 which are independently raised and lowered by actuators connected to the computer C as described above with respect to the apparatus and system of FIGS. 10 and 11.

The use of the processing system 190 eliminates much of the complexity and timing requirements encountered in regard to applying documents to a continuously moving conveyor. In operation, the upstream conveyor 182′″ is operated by its motor drive to index and advance containers 24 onto the conveyor 182′ when the computer generates a signal that the conveyor 182′ has sufficient capacity to receive another container 24. Once received on the conveyor 182′, the scannable indicia 156 is read by the upstream scanner 192 and a signal is then sent to the computer, which sends a corresponding signal to the printing and applicating machine 160′ as to what information to print onto the first document 20. The motor drive 184′ moves the container 24 downstream along the conveyor 182′ until the container 24 is positioned adjacent the first printing and applicating machine 160′. When the container 24 advances into a position where its leading edge is detected by the position indicator 164′, the position indicator 164′ sends a signal to the computer C, which in turn signals the motor drive 184′ to stop the conveyor 182′. Once the container's movement is stopped (either by detecting the absence of movement by the position indicator or by a responsive signal from the motor drive 184′ to the computer), the computer signals the printing and applicating machine 160′ to begin operation. Upon actuation, the printing and applicating machine 160′ advances the continuous document supply strip 30 to move the first document 20 into position to be printed and then the first document 20 is removed from the carrier sheet 28″ and the applicator arm 162′ applies the first document to the container as illustrated in FIG. 12. Advantageously, using the system of FIG. 12, multiple versions of the first document 20 may be printed and applied to the container 24. For example, one or two first documents 20 may be applied one atop another in registry. This would be particularly advantageous where the information to be printed exceeds the area available for printing on the center portion of one first document 20, or where a document of a different informational content is desired. For example, if the first document 20 is used as a packing list and the contents to be printed exceed the available area on the center portion of one first document, an additional first document may be printed and applied by the printing and applicating machine 160′. Another example where two first documents 20 would be desired is where one first document 20 was used as a packing list and another first document 20 was desired to have the center portion printed as a return postcard. The ability to print two such first documents 20 in superposed relationship is illustrated by FIG. 5. Because of the printing capabilities of the printing and applicating machinery, it is possible that there is no preprinting on the first documents on the document supply strip 26′, such that all printing thereon is variably printed on demand. After the first document(s) 20 is applied, the computer signals the motor drive 184′ to reactuate the conveyor to move the container 24 with the first document 20 thereon downstream past the scanner 194, which detects that the first document 20 has been properly applied in the correct position and communicates that information to the computer. The container 24 is advanced downstream and then delivered to the conveyor 182″. The conveyor 182′ is separated from the conveyor 182″, at least operationally, so that advancement of the containers along the conveyor 182′ is independent of advancement of the containers on the conveyor 182″, as each will be periodically stopped while the respective documents are applied.

The container 24 is then advanced down the conveyor 182″ until the container 24 is positioned adjacent the second printing and applicating machine 160″. The second printing and applicating machine 160″ is positioned complementally to the first printing and applicating machine 160′ such that the second document will be placed in registry with the first document as illustrated in FIG. 5 or in FIGS. 8 and 9. When the container 24 advances into a position where its leading edge is detected by the position indicator 164″, the position indicator 164″ sends a signal to the computer C, which in turn signals the motor drive 184″ to stop the conveyor 182″. Once the container's movement is stopped (either by detecting the absence of movement by the position indicator or by a responsive signal from the motor drive 184″ to the computer), the computer signals the printing and applicating machine 160″ to begin operation. Upon actuation, the printing and applicating machine 160′ advances the continuous document supply strip 31 to move the second document 22 into position to be printed and then the second document 22 is removed from the carrier sheet 28″ and the applicator arm 162″ applies the second document to the container in registry and in covering relationship to the first document 20 as illustrated in FIG. 12. After the second document 22 is applied, the computer signals the motor drive 184″ to reactuate the conveyor 182″ to move the container 24 with the second document 22 positioned atop the first document 20 downstream past the scanner 196, which detects that the second document 22 has been properly applied in the correct position and communicates that information to the computer. The completed system 138 (or 138A) is advanced downstream and is then ready to leave the conveyor 182″ for further processing or delivery.

Common to each of these systems is the fact that the documents are printed and applied in registry to a container or other substrate, that the first document is first applied and then the second document thereon such that removal of the center section of the second document having a substantially adhesive-free reverse side gives access to a previously masked, removable center portion of the first document also having a substantially adhesive-free back side, and that the first and second documents are each applied while the container is substantially stationary. As a result, the first document, for example a packing list, can remain masked until it reaches the identified recipient or evidence tampering in the interim, while placement of the second document in a masking position is more easily and reliably accomplished because the container is stopped during the application process. In certain of the processes and systems described herein, the reliable and accurate positioning of the second document is further enhanced by the fact that the first and second documents may be carried on a common continuous supply strip such that they are preprinted in longitudinal alignment and fed one after another to a common applicating machine for printing and application. This combination of alternating first and second documents on a common continuous document supply strip, which promotes lateral alignment, and the fact that the container is stopped during application to promote improved longitudinal (upstream to downstream) alignment presents substantial improvements in the resulting quality of the applied document systems 138 and 138A.

Although preferred forms of the invention have been described above, it is to be recognized that such disclosure is by way of illustration only, and should not be utilized in a limiting sense in interpreting the scope of the present invention. For example, with the container stationary, the first and second documents could be sequentially applied in registry one atop another, the first and second documents being fed individually from magazines as part of the printing and applicating machines. The first and second documents in such an instance could be carried by individual rather than continuous carrier sheets, or the adhesive could be a wettable adhesive activated by the application of moisture or by adhesive that is activated by heat, such as a thermally activated adhesive which may be applied and activated by one or more of the printing and applicating machines. While first and second documents have been illustrated in the preferred embodiments, it is also to be understood that the invention encompasses applications where three or more documents are sequentially delivered for application in registry one atop another. The second document may be applied in such a manner that it adheres directly to the container without adhesive engagement with the first document as shown in FIG. 5, or that it adheres directly to portions of the first document without adhesive engagement with the container, or that it adheres both to portions of the first document and to the container as illustrated in FIGS. 13 and 14. Also, while the application arm 162 is shown oriented for substantially horizontal reciprocation to apply the documents to the side of the containers 24, such is by way of illustration only and it should be understood that other apparatus to print and apply the documents 20 and 22 may be used, or that a printing and applicating machine 160 may be employed with an applicator arm 162 oriented for vertical movement to apply the documents on the top side of the container 24 on the platform or conveyor. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of his invention as pertains to any process, system or apparatus not materially departing from but outside the literal scope of the invention as set out above or in claims made pursuant to the foregoing disclosure.

1. A process for sequentially applying documents in registry to a substrate in superposed, aligned relationship, comprising:
providing first and second documents and a substrate for receiving the documents, the second document having at least and portion thereof detachable from a remaining portion along lines of weakness, said portion being substantially free of adhesive;
adhesively applying the first document to the substrate;
adhesively applying the second document to one or both of the substrate and portions of the first document, with a portion being applied in covering relationship over at least a part of the first document and said portion being detachable from said remaining portion without adhering to said first document; and
maintaining the substrate substantially stationary while adhesively applying at least one of said first document and said second document.

2. The process of claim 1, wherein maintaining step includes maintaining said substrate substantially stationary while adhesively applying the first document to the substrate.

3. The process of claim 2, wherein the maintaining step includes maintaining said substrate substantially stationary while adhesively applying the second document to one or both of the substrate and portions of the first document.

4. The process of claim 3, wherein the maintaining step is carried out at a single application station.

5. The process of claim 4, including the step of printing indicia upon each of said first document and said second document at a single application station.

6. The process of claim 1, wherein the substrate is maintained substantially stationary while adhesively applying the second document to one or both of the substrate and portions of the first document.

7. The process of claim 1, including the step of printing indicia upon at least one of said first document and second document at a single application station.

8. The process of claim 7, including the steps of sequentially printing indicia upon and applying said first and second documents respectively at said single application station.

9. The process of claim 1, said maintaining step being carried out on a stationary support for said substrate.

10. The process of claim 1, said maintaining step being carried out on a shift able conveyor.

11. The process of claim 1, said maintaining step being carried out on respective first and second independently shift able conveyor, there being apparatus for printing indicia upon and applying the first and second documents at each of said first and second conveyor.

12. The process of claim 1, including the step of moving said substrate after application of said first document and prior to application of said second document.

13. A continuous document supply material for supplying documents to be applied to a receiving substrate, comprising:
a carrier web having a release coating on at least one side thereof;
a plurality of first documents adhesively attached to said one side of said carrier web; and
a plurality of second documents different from said first documents adhesively attached to said one side of said carrier web in substantial longitudinal alignment and sequentially alternating relationship with said first documents whereby during feeding of said continuous material in an applicating apparatus, said first and second documents may be alternately removed from said carrier web and applied to a single substrate.

14. The material of claim 13, said second documents being sized and oriented for application over at least a part of said first document.

15. The material of claim 13, each of said first documents being associated with the immediately adjacent second document, and both the first and second documents bearing information about a respective single substrate.

16. The material of claim 15, said information being provided as scannable information comprising radio frequency identification labels and bar codes.

17. The material of claim 13, said first document being packing lists, said second documents being shipping labels.

18. Apparatus for printing and applying documents to a substrate in superposed, covering relationship, comprising:
a support for receiving thereon a substrate;
at least one printing and applicating machine positioned adjacent said support for printing documents and adhesively applying the documents to the substrate,
wherein said printing and applicating machine comprises a continuous document supply strip including a carrier strip having a plurality of alternating and different first and second documents releasably adhered thereto, and an assembly operable to receive said document supply strip, printing variable indicia on one of said first documents, and adhesively applying said one of said first document to said substrate, and then printing variable indicia on one of said second documents, and adhesively applying said one of said second documents in superposed, substantially covering relationship over at least a part of said first document.

19. The apparatus of claim 18, said support selected from the group consisting of a stationary platform, and at least one shift able conveyor.

20. The apparatus of claim 18, comprising only a single printing and applicating machine.

21. The apparatus of claim 18, said support comprising a plurality of independently shift able conveyor, there being a printing and applicating machine adjacent each of said machines.

22. The apparatus of claim 18, said supply strip having second documents sized and oriented for application over at least a part of the adjacent first documents.

23. The apparatus of claim 18, each of said first documents being associated with the immediately adjacent second document, and both the first and second documents bearing information about a respective single substrate.

24. Apparatus for printing and applying documents to a substrate in superposed, covering relationship, comprising:
a first conveyor adapted for moving a substrate therealong;
a second conveyor positioned downstream from said first conveyor, said second conveyor being operable to move a substrate independently of said first conveyor;
a first printing and applicating machine positioned adjacent said first conveyor and operative to printing upon them adhesively applying a first document to a substrate when said first conveyor advances a substrate into a position adjacent said first printing and applicating machine;
a second printing and applicating machine positioned adjacent said second conveyor and operative to print upon them adhesively applying a second document to the substrate when said second conveyor receives the substrate from the first conveyor and advances the substrate into a position adjacent said second printing and applicating machine; and
a control unit operatively coupled with said first conveyor, said second conveyor, said first printing and applicating machine and said second applicating machine, whereby said control unit is operative to substantially stop movement of the substrate along said first conveyor and said second conveyor respectively prior to and during application of said first and second documents to the substrate.
